(19) United States
(12) Patent Application Publication
(10) Pub. No.: US 2010/0060567 A1
(43) Pub. Date: Mar. 11, 2010

(54) CONTROLLING DEVICE OPERATION RELATIVE TO A SURFACE

(75) Inventor: Glen C. Larsen, Issaquah, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/204,832

(22) Filed: Sep. 5, 2008

(51) Int. Cl. G09G 5/00; G06F 3/033

(52) U.S. Cl. 345/156; 345/166

(57) ABSTRACT

Architecture for automatic switching between multiple modes in a handheld device such as a mouse based on the presence of specular light, or lack thereof. When applied to a presenter mouse, the architecture facilitates the automatic switching between mouse mode and presenter mode without manual intervention by the user. An optical approach is well suited since most optical systems include a light source, lenses, and light sensors to detect reflected light from the source (or lack thereof). The approach leverages the existing light source and lenses in a mouse to minimize incremental cost, yet provide a robust technique for detecting lift from the tracking surface thereby automatically switching between modes as the user moves the mouse on and off the tracking surface. A delay circuit and/or image comparison can also be provided that eliminates undesirable triggering to a different mode by preventing unintended switching between the multiple modes.

### BACKGROUND

The optical mouse is a common input device used to interact with a computer by moving the mouse on a tracking surface in a work area where generally the user is seated while tracking on a stationary object. Other handheld remote control devices are used to command a presentation projected or displayed on a large screen for viewing by an audience.

Products have been introduced into the marketplace that combine the functions of a computer mouse and a presenter device into a presenter mouse. The presenter mouse contains a typical optical navigation system, allowing it to function as a regular mouse while on a tracking surface, and also contains a system for controlling a presentation stored on a remote computer.

Since the mouse navigation system is different from the presentation control system, the user has to manually switch between mouse mode and presenter mode so that control motions are not picked up inadvertently by the system not currently in use. Typically, this has been accomplished with a switch (e.g., electrical, mechanical) whereby the user interacts with the switch to move between the modes. This can be by way of a single switch which is toggled to alternate between the modes or separate switches to choose one mode or the other, for example.

Since a presenter mouse that employs the combined functionality is typically used bottom down with surface contact in mouse mode and bottom up in presenter mode, this automatic mode switching can be accomplished in several ways. A mouse usually operates on a flat horizontal surface; thus, tilt switches such as mercury switches or other fluid based switches could be used to detect a change in the mouse orientation away from the horizontal plane. However, tilt systems work only for horizontal tracking surfaces, and the consumer may need to use the mouse normally on a non-horizontal surface, such as when leaning back in a chair with a laptop. Motion detectors such as accelerometers or gyroscopes could also be used instead of tilt switches, but an undesirable calibration step is required when tracking on surfaces in a variety of non-horizontal orientations. Moreover, each of these introduces unwanted cost in what should be a relatively inexpensive device.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture introduces an optical approach in a system that facilitates automatic switching between multiple user modes based on the presence of reflected (e.g., specular) light, or lack thereof. When applied to a presenter mouse, the architecture facilitates the automatic switching between mouse mode and presenter mode without manual intervention by the user. An optical approach is well suited since most optical systems include a light source, lenses, and light sensors to detect reflected light from the source (or lack thereof).

The approach leverages the existing light source and lenses in a mouse to minimize incremental cost, yet provide a robust technique for detecting lift from the tracking surface thereby automatically switching between modes as the user moves the mouse on and off the tracking surface.

A delay circuit can also be provided that eliminates undesirable triggering to a different mode by providing a short delay before switching between the multiple modes. For example, when employed in a multimode presenter mouse, the circuit prevents auto-switching to presenter mode based on an inadvertent clutch or lift of the mouse from the tracking surface when in mouse mode.

To the accomplishment of the foregoing and related ends, certain illustrative aspects are described herein in connection with the following description and the annexed drawings. While these aspects are indicative of the various ways in which the principles disclosed herein can be practiced, all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a multimode control system for a handheld device.

FIG. 2 illustrates a multimode control system for a handheld device such as a presenter mouse.

FIG. 3 illustrates an optical system that includes an image sensor for receiving both the specular tracking light and specular switching light for control switching in accordance with one implementation of the disclosed architecture.

FIG. 4 illustrates an optical system that includes the image sensor for receiving the specular tracking light and a photodetector for receiving the specular switching light for control switching in accordance with one implementation of the disclosed architecture.

FIG. 5 illustrates an optical system that includes the image sensor for receiving the specular tracking light and the photodetector for receiving the specular switching light for control switching in accordance with one implementation of the disclosed architecture.

FIG. 6 illustrates an alternative system for redirecting specular light to a photodiode using a single prism.

FIG. 7 illustrates a method of multimodal optical switching in a handheld device.

FIG. 8 illustrates a method of multimodal switching based on an integrated light on an image sensor.

FIG. 9 illustrates a method of multimodal switching based on a photodetector.

FIG. 10 illustrates an exemplary presenter mouse that provides automatic switching between tracking mode and presenter mode.

FIG. 11 illustrates a block diagram of a computing system operable to interface to the disclosed automatic switching device architecture.

### DETAILED DESCRIPTION

The disclosed architecture facilitates the automatic switching between multiple operating modes based on the presence of specular light, or lack thereof. When applied to a presenter mouse, the architecture facilitates the automatic switching between at least mouse mode and presenter mode without manual intervention by the user. The approach can leverage the existing light source and lenses in a mouse, for example, to minimize incremental cost, yet provide a robust technique for detecting lift from the tracking surface thereby automatically switching between modes as the user moves the presenter mouse on and off the tracking surface.

In the presenter mouse, the light source illuminates and directs the light to the light sensor by reflecting the light off the tracking surface when the device is in contact with (or close proximity to) the tracking surface. No light (or an insufficient amount) is returned to the light sensor in the absence of the tracking surface due to lack of a reflecting surface.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

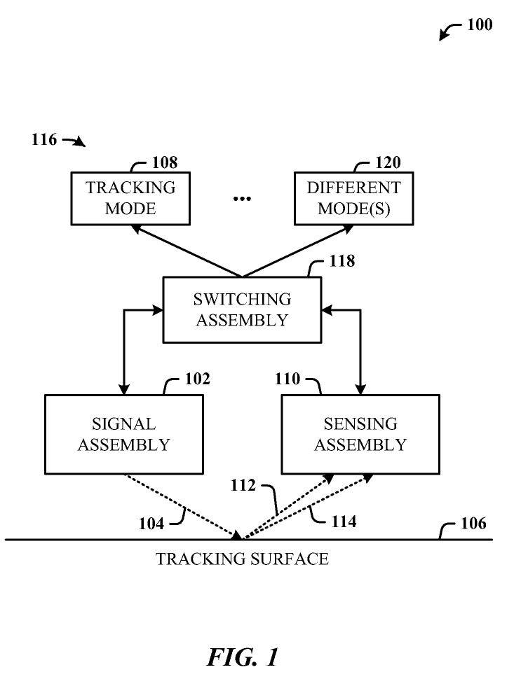

FIG. 1 illustrates a multimode control system 100 for a handheld device. The control system 100 includes a signal assembly 102 for imposing a signal 104 (e.g., electromagnetic radiation such as light, infrared, radio, etc.) on a tracking surface 106 (e.g., desktop, table, etc.) in a tracking mode 108 (such as for a mouse). The system 100 can also include a sensing assembly 110 for sensing a reflected tracking portion 112 of the imposed signal 104 from the tracking surface 106 to track the movement of a device (which the system 100 is associated) relative to the tracking surface 106 and a reflected switching portion 114 of the imposed signal 104 from the tracking surface 106 for mode switching between multiple modes 116 (e.g., the tracking mode and different modes).

A switching assembly 118 of the system 100 automatically switches between the tracking mode 108 and one or more different modes 120 based on sensing (or non-sensing) of the reflected switching portion 114 by the sensing assembly 110. The switching assembly 118 can include the logic of circuit elements that provide the switching function based on changes in signal state obtained from the sensing elements. It is to be appreciated that a user control can be provided such that the user can manually switch between the tracking mode 108 and the one or more different modes 120, rather than use auto-switching, if desired.

The sensing assembly 110 can include an image sensor (e.g., charge coupled device (CCD), complementary metal oxide semiconductor (CMOS) or other sensor technologies) that receives both the reflected tracking portion 112 and the reflected switching portion 114, such that the switching assembly 118 then automatically switches between the tracking mode 108 and a different mode of the different modes 120 based on an integration of light received at the image sensor. Note that although illustrated as two separate paths, in an alternative implementation, the reflected tracking portion 112 and reflected switching portion can be along coincident paths.

Alternatively, the sensing assembly 110 can include an image sensor that receives the reflected tracking portion 112 to track the movement of the device and a second photosensing mechanism such as a photodiode or a second image sensor for sensing (a sufficient amount of the reflected switching portion 114 from the imposed signal 104) or non-sensing (an insufficient amount) of the reflected switching portion 114.

The signal assembly 102 can include optical components (e.g., light sources such as LASER (light amplification by stimulated emission of radiation, hereinafter referred to throughout this description as “laser”) or LED, lenses, optical through ports, etc.) for imposing the signal 104, which is an optical signal (e.g., light), on the tracking surface 106 for tracking movement of the device. In a more specific embodiment, the sensing assembly 110 includes an optical detector for sensing the reflected switching portion 114 of the signal 104 (which is an optical signal) from the tracking surface 106 when the device is in contact with the tracking surface 106. The switching assembly 118 automatically maintains the device in the tracking mode 108 in response to the sensing of the reflected switching portion 114.

In an embodiment where the device that includes the system 100 is a presenter mouse, the presenter mouse will function as a mouse when the device is in contact with the tracking surface 106, and auto-switch to presenter mode (one of the different modes 120) when the device is moved away from the tracking surface 106. In this way, the user does not need to manually switch between the various modes 116.

It is also within contemplation that direct contact with the tracking surface 106 is not required, but that auto-switching can occur when the device is sufficiently proximate the tracking surface 106. In other words, when in presenter mode and then bringing the device to the tracking surface 106, the switching assembly 118 will auto-switch to tracking (or mouse) mode when close to, but not yet in contact with, the tracking surface 106. In operation, the signal assembly 102 imposes an optical signal toward the tracking surface 106 for tracking movement of the device, the sensing assembly 110 includes a photodetector for detecting (absence or presence of) the reflected switching portion 114 of the optical signal from the tracking surface 106 when the device is proximate the tracking surface 106, and the switching assembly 118 automatically switches the device from presenter mode to the tracking mode 108 in response to the sensing of the reflected switching portion 114.

Conversely, when in tracking mode 108 and then moving the device away from the tracking surface 106, the switching assembly 118 auto-switches to presenter mode when sufficiently out of optical range of the tracking surface 106, even after losing contact with the tracking surface 106. In operation, the signal assembly 102 imposes the optical signal on the tracking surface 106 for tracking movement of the device relative to the tracking surface 106, the sensing assembly 110 includes the photodetector for detecting presence of the reflected switching portion 114 of the optical signal from the tracking surface 106 when the device is in contact and sufficiently proximate the tracking surface 106. The switching assembly 118 automatically switches the device from tracking mode 108 to presenter mode in response to the photodetector not sensing the reflected switching portion 114.

The system 100 can also include delay logic for delaying the automatic switching between the tracking mode 108 and the one or more different modes 120. The delay logic can be part of the switching assembly 118.

As will be described herein below, the imposed signal and/or the reflected signals can be redirected through the system 100 using various mechanisms such as lenses, optical couplers, prisms, and so on, when employing optical signals.

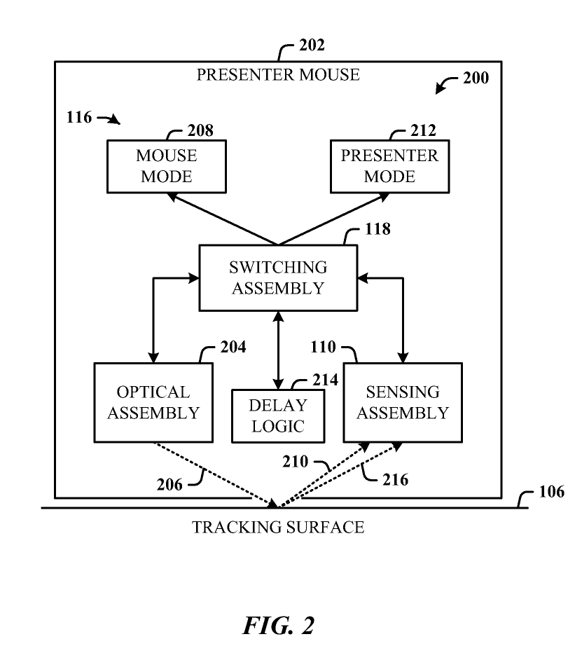

FIG. 2 illustrates a multimode control system 200 for a handheld device such as a presenter mouse 202. The control system 200 includes an optical assembly 204 (or more generally, the signal assembly 102) for imposing incident light 206 on the tracking surface 106 in a mouse mode 208 (similar to the tracking mode 108 of FIG. 1). The system 200 also includes the sensing assembly 110 (which includes optical sensing components and can include other optical elements such as prisms, lenses, etc.) for sensing tracking light 210 (similar to the reflected tracking portion 112 of FIG. 1) from the tracking surface 106 to track the movement of the presenter mouse 202 relative to the tracking surface 106. The control system 200 also includes the switching assembly 118 for automatically switching between the mouse mode 208 and a presenter mode 212 (one of the different modes 120 of FIG. 1) based on sensing (absence or presence) of the tracking light 210. The system 200 can further comprise delay logic 214 for delaying the automatic switching between the mouse mode 208 and the presenter mode 212 according to a predetermined or learned delay value (e.g., 500 milliseconds).

The sensing assembly 110 can include an image sensor that senses the tracking light 210, and the switching assembly 118 automatically switches between the mouse mode 208 and the presenter mode 212 based on a light threshold level of the tracking light 210 received at the image sensor.

Alternatively, the sensing assembly 110 includes an image sensor that senses the tracking light 210, and additionally, a photodiode for sensing specular switching light 216 from the tracking surface 106, and the switching assembly 118 automatically switches to the presenter mode 212 based on absence of the specular switching light 216 sensed at the photodiode. In order to accommodate existing mechanical configurations of presenter mice as a way to maintain low costs, the specular switching light 216 can be rerouted off the specular path to an offset position where the photodiode may be sited, using an arrangement of optical elements (e.g., lenses, prisms, etc.). This is illustrated herein below.

Moreover, the optical assembly 204 can employ a laser light source for imposing the incident light 206 or an LED light source for imposing the incident light 206. The light source can be employed with an optical element (e.g., lens, prisms, etc.) arrangement that provides directed light along the specular path. It is also to be appreciated that the tracking light 210 and the switching light 216 can be on coincident light paths.

As a general summary of an optical architecture and optional features that can be employed to achieve the desired multimode control functionality, an optical presenter mouse can include mouse functionality for operating as a mouse using a laser light source or an LED light source (the light source for the auto-switching can be the mouse light source or a separate light source); an optional collimating lens (e.g., combined with an existing mouse lens part, or separate lens part), the collimating lens may not be needed if the light is already collimated; one or more optional lens(es) that direct specular (reflected) light to a detector or image sensor (no lens is used if the specular path aligns directly to mouse imaging sensor); “periscope” prisms can be used to offset (redirect) the specular path of the switching light to an adjacent detector; a lens with no power (window) or lens hole can be used if no optical redirection is performed; the sensing assembly 110 can include the mouse imaging sensor for both tracking and switching, or a separate light detector for the switching detection); and, a circuit that introduces a delay, or other logic, before switching from mouse mode 208 to presenter mode 212, and back, to distinguish picking up the mouse from a clutching move by the user.

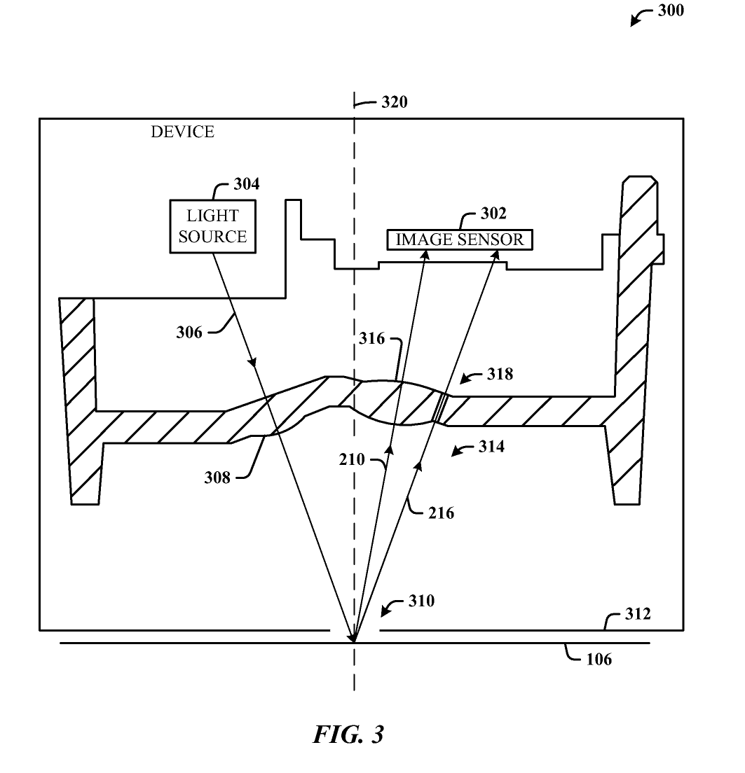

FIG. 3 illustrates an optical system 300 that includes an image sensor 302 for receiving both the tracking light 210 and specular switching light 216 for control switching in accordance with one implementation of the disclosed architecture. Here, a single light source 304 (e.g., a laser, LED, etc.) emits light along an incident path 306 onto the tracking surface 106 using an incident lens 308 to direct incident light through a hole or window 310 in the device housing 312. The reflected light 314 includes the tracking light 210 which is focused on a section of the image sensor 302 using an optical element such as a tracking lens 316. The specular switching light 216, as a portion of the scattered reflected light 314 can be directed to another section of the image sensor 302 via an optical throughport, hole, or window 318.

In many mice based on laser illumination, the incident path 306 is about twenty degrees relative to a normal 320, and the image sensor 302 is located on a path about ten degrees off the normal 320. This can mean that most of the reflected (specular) light bounces off the tracking surface 106 and is discarded as stray light. However, the presence of the reflected light 314 indicates the presence of a reflective surface (the tracking surface 106), and by placing the image sensor 302 on the specular path of the switching light 216 as well, a signal can be generated based on exceeding a predetermined light threshold level, which indicates the mouse is on or proximate the tracking surface 106.

A signal less than the threshold level can indicate that the mouse (the device) has been picked up, or is no longer on a tracking surface 106. In the absence of the tracking surface 106, and after a specific time delay, the mouse can be instructed to go into presenter mode. Thereafter, a periodic check can be made for the light level to exceed the threshold level (indicating again the presence of the tracking surface 106). The delay can be predetermined or learned to allow for mouse clutching by the user without automatically triggering into presenter mode, or vice versa. In one example, the delay time can be set to about 500 milliseconds.

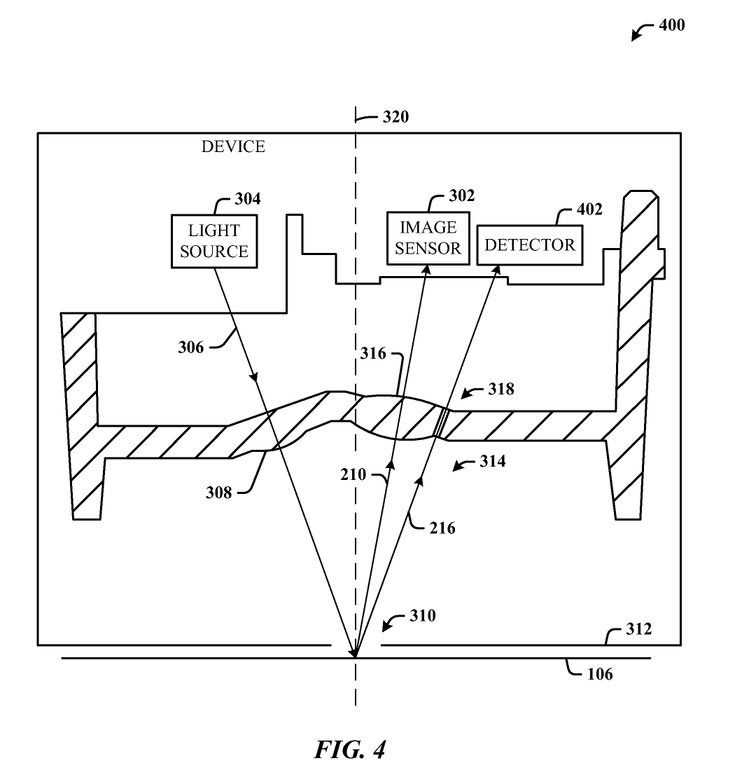

FIG. 4 illustrates an optical system 400 that includes the image sensor 302 for receiving the tracking light 210 and a photodetector 402 for receiving the specular switching light 216 for control switching in accordance with one implementation of the disclosed architecture. The single light source 304 emits light along the incident path 306 onto the tracking surface 106 using the incident lens 308 to direct the incident light 306 through the hole or window 310 in the device housing 312.

The reflected light 314 includes the tracking light 210 which is directed on the image sensor 302 using an optical element such as the tracking lens 316. Here, the specular switching light 216, as a portion of the reflected light 314, can be directed to a separate sensing element such as the photodetector 402 via the optical throughport 318.

The incident path 306 can be about twenty degrees relative to the normal 320, and the image sensor 302 is located on a path about ten degrees off the normal 320. The photodetector 402 can be placed about twenty degrees off the normal 320 in the specular path to receive the specular switching light 216 for mode switching. Absence of detected specular light can be interpreted as not being in contact with the tracking surface 106, which will switch to presenter mode, and presence of the specular switching light 216 indicates contact with the tracking surface 106. The delay circuit (or logic) can also be employed such that after a specific time delay, the presenter mouse can be instructed to go from mouse mode to presenter mode. The delay can be predetermined or learned to allow for mouse clutching by the user without going automatically triggering into presenter mode. In one example, the delay time can be set to about 500 milliseconds.

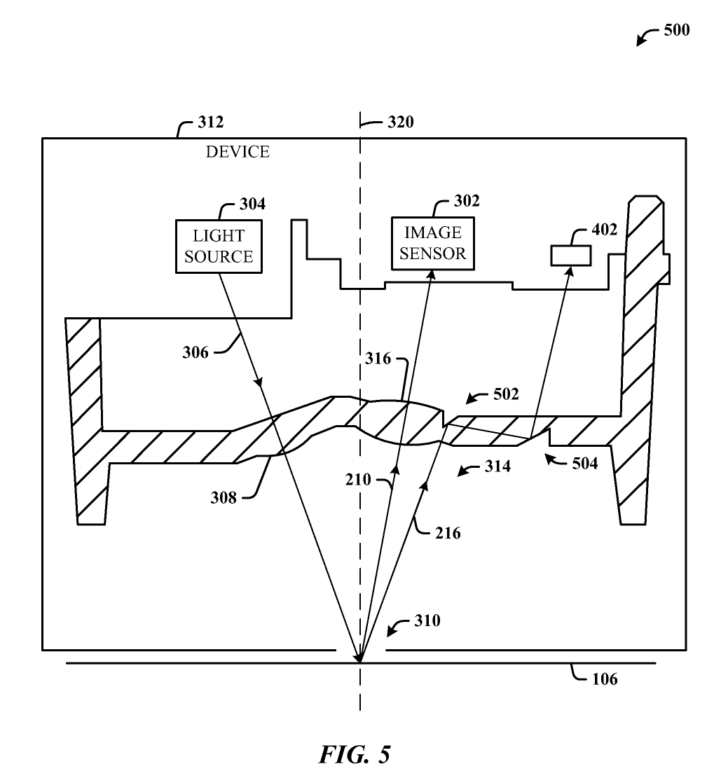

FIG. 5 illustrates an optical system 500 that includes the image sensor 302 for receiving the tracking light 210 and the photodetector 402 for receiving the specular switching light 216 for control switching in accordance with one implementation of the disclosed architecture. The single light source 304 emits light along the incident path 306 onto the tracking surface 106 using the incident lens 308 to direct incident light through the hole or window 310 in the device housing 312.

The reflected light 314 includes the tracking light 210 which is directed on the image sensor 302 using an optical element such as the tracking lens 316. Here, the specular switching light 216, as a portion of the reflected light 314, can be redirected according to a repositioning of the photodetector 402 via optical elements 502 and 504, such as prisms.

The incident path 306 can be about twenty degrees relative to the normal 320, and the image sensor 302 can be located on a path about ten degrees off the normal 320. The photodetector 402 can be located in any convenient place in the device housing 312 given that the redirection can be facilitated by a set of optical elements to route the specular switching light 216 to the photodetector 402.

As before, the detected absence of specular switching light 216 can be interpreted as not being in contact with the tracking surface 106, which will auto-switch to presenter mode, and the detected presence of the specular switching light 216 indicates contact with the tracking surface 106. The delay circuit (or logic) can also be employed such that after a specific time delay, the presenter mouse can be instructed to go from mouse mode to presenter mode. The delay can be predetermined or learned to allow for mouse clutching by the user without going automatically triggering into presenter mode. In one example, the delay time can be set to about 500 milliseconds.

Note that in all instances of utilizing a delay circuit, an image comparison process can be performed instead, the results of which indicate if the mode will be switched. For example, if the compare results in a logic high, this can indicate a successful compare and that switching should occur.

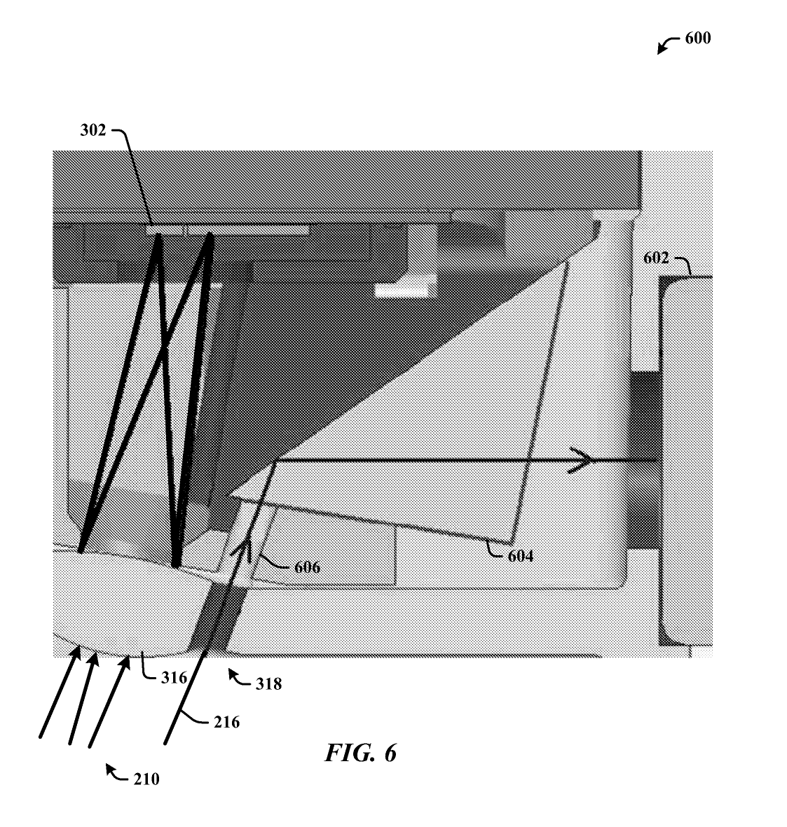

FIG. 6 illustrates an alternative system 600 for redirecting specular light to a photodiode 602 using a single prism 604. The tracking light 210 is collected by the lens 316 for directing to the image sensor 302. Additionally, some of the light is the specular switching light 216 which passes via the throughport 318 to the prism 604. This can also be improved using a collimating coupler 606 to the prism 604.

As can be appreciated in the previous embodiments, when the image sensor 302 is located on the specular path, a separate photodiode for mode switching is not utilized, and the overall light threshold is an integration of the light at all pixels of the image sensor 302. In this most general case, no additional mechanical or optical components are required, since the system leverages the existing illumination source, existing lens(es), and the existing imaging sensor 302 as the detector.

Moreover, existing laser illumination can be leveraged eliminating the need for an additional light source along the specular path, and the specular paths can all be driven by optical surfaces in an existing lens, thereby requiring the photodiode 602 as the only added component. In yet another embodiment, an LED is used as the mouse's primary light source rather than the laser, and a collimating lens can be used to provide directed light along the specular paths.

Where the device (e.g., presenter mouse) employs an indicator that indicates when the device is in contact with the tracking surface, the indicator signal can be used for mode switching. For example, if the indicator is off, the presenter mouse can be switched to presenter mode; otherwise, the indicator is on and the presenter mouse is in tracking mode.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

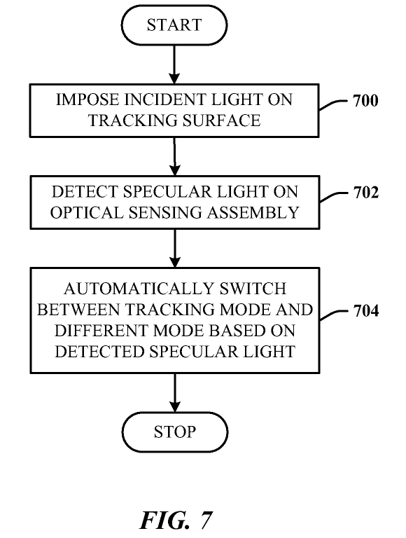

FIG. 7 illustrates a method of multimodal optical switching in a handheld device. At 700, incident light is imposed on a tracking surface. At 702, specular light on an optical sensing assembly is detected. At 704, switching is automatically performed between a tracking mode and a different mode based on the detected specular light.

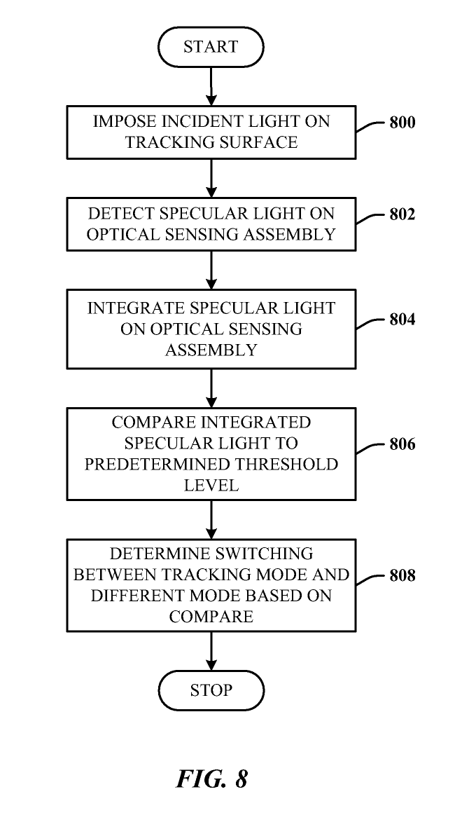

FIG. 8 illustrates a method of multimodal switching based on integrated light on an image sensor. At 800, incident light is imposed on a tracking surface. At 802, specular light on an optical sensing assembly is detected. At 804, specular light on the optical sensing assembly (e.g., an image sensor) is integrated. At 806, the integrated specular light is compared against a predetermined threshold level. At 808, switching between the tracking mode and the different mode is automatically determined based on the compare.

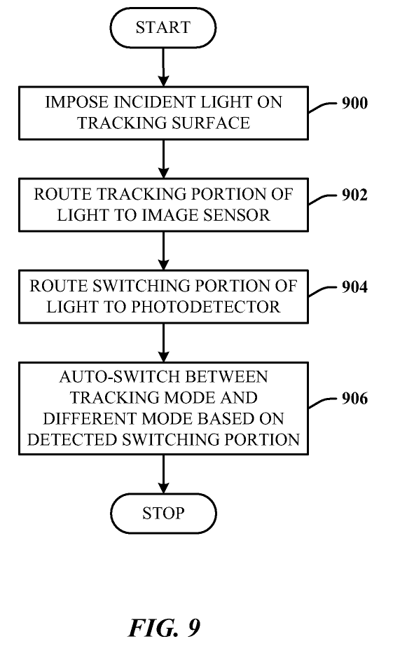

FIG. 9 illustrates a method of multimodal switching based on a photodetector. At 900, incident light is imposed on a tracking surface. At 902, a tracking portion of the light is routed to an image sensor. At 904, the specular light is routed to a photodetector. At 906, switching is automatically performed between the tracking mode and the different mode based on the detected switching portion.

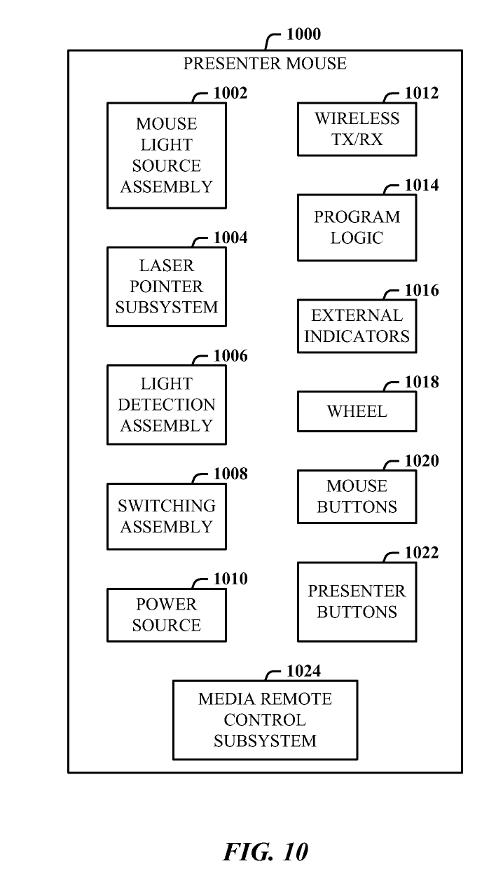

FIG. 10 illustrates an exemplary presenter mouse 1000 that provides automatic switching between tracking mode and presenter mode. The presenter mouse 1000 can include a light source assembly 1002, which can include light sources such as a laser, an LED, combinations of the laser and LED, or multiples of light sources. The light source assembly 1002 can also include optical elements such as lenses, collimators, and so on, utilized to achieve the desired tracking and switching modes.

The presenter mouse 1000 can also include a laser pointer subsystem 1004 for emitting a laser spot to a presentation surface for pointing and directing viewer attention. This can be accomplished using an additional laser subsystem to the tracking function, or using the same laser subsystem by redirecting the tracking laser using an assembly of redirecting optics (e.g., prisms, couplers, etc.).

The presenter mouse 1000 also includes a light detection assembly 1006 for detecting light from the tracking surface for both tracking and switching functions. The light detection assembly 1006 can include an image sensor normally used for tracking, and one or more photodiodes for detecting the specular switching light. As previously indicated, if the image sensor is placed on the specular path, it can be used wholly for both the tracking function and the switching function.

A switching assembly 1008 includes the logic for receiving a signal based on the detection or absence of detection of the specular switching light, and switching between the various modes in accordance with the state of that signal. For example, if the state of the signal is logic high, this can correspond to detection of the specular switching light, indicating that the presenter mouse 1000 is in contact with the tracking surface. The switching assembly 1008 will then ensure that switching is to tracking (or mouse) mode.

The presenter mouse 1000 can also include a power source 1010 such as batteries and/or a power converter for using line power. A wireless transceiver subsystem 1012 facilitates wireless communications (e.g., Bluetooth, 27 MHz, 2.4 GHz, etc.) such as in a mouse mode, for example. Program logic 1014 provides the operating software for the presenter mouse 1000 for interfacing to a computer system, for example, or other systems, as well as for onboard control of the presenter mouse functions. External indicators 1016 can be provided to give feedback to the user for such functions as power, mode operation, and so on. A wheel 1018 can be provided for scrolling and other navigation operations normally associated with a wheel mouse. Mouse buttons 1020 facilitate operating the presenter mouse 1000 as a mouse. These can be programmable functions for the mouse buttons. Presenter buttons 1022 facilitate operating the presenter mouse 1000 in the presenter mode. These buttons may be some or all of the same physical buttons as in mouse mode, with their function being based on the state of the mode detection. A media remote control subsystem 1024 provide the functionality for using the presenter mouse 1000 as a media remote control unit, such as playing a CD, DVD, audio files, etc.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

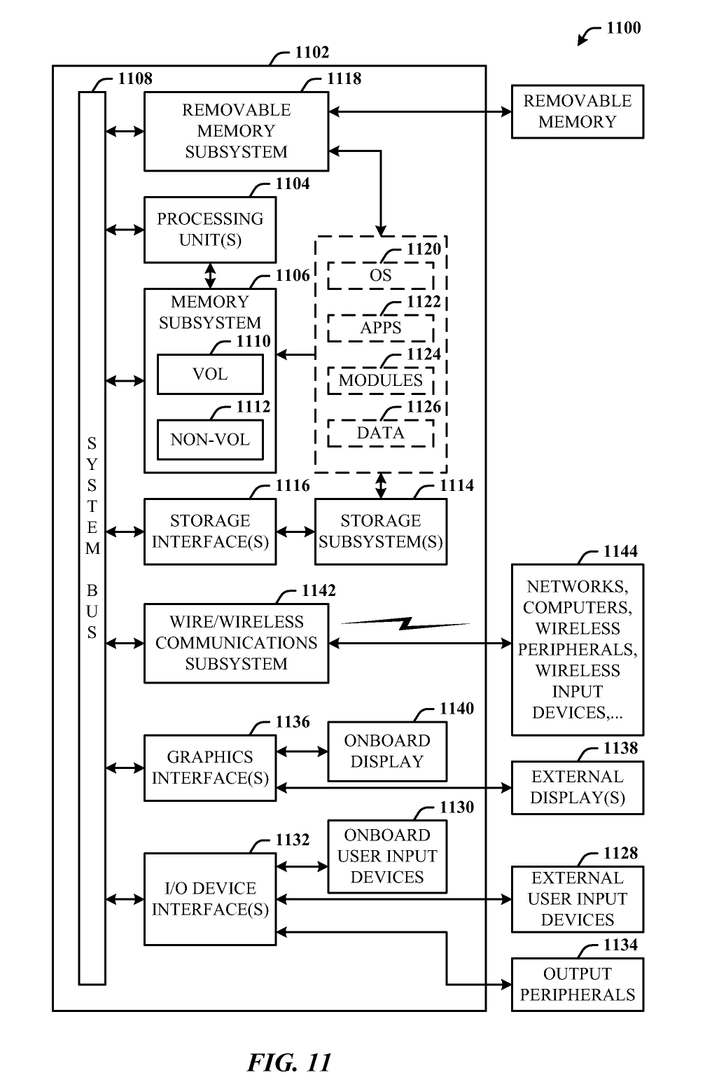

Referring now to FIG. 11, there is illustrated a block diagram of a computing system 1100 operable to interface to the disclosed automatic switching device architecture. In order to provide additional context for various aspects thereof, FIG. 11 and the following discussion are intended to provide a brief, general description of the suitable computing system 1100 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1100 for implementing various aspects includes the computer 1102 having processing unit(s) 1104, a system memory 1106, and a system bus 1108. The processing unit(s) 1104 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1106 can include volatile (VOL) memory 1110 (e.g., random access memory (RAM)) and non-volatile memory (NON-VOL) 1112 (e.g., ROM, EPROM, EEPROM, etc.). A basic input/output system (BIOS) can be stored in the non-volatile memory 1112, and includes the basic routines that facilitate the communication of data and signals between components within the computer 1102, such as during startup. The volatile memory 1110 can also include a high-speed RAM such as static RAM for caching data.

The system bus 1108 provides an interface for system components including, but not limited to, the memory subsystem 1106 to the processing unit(s) 1104. The system bus 1108 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1102 further includes storage subsystem(s) 1114 and storage interface(s) 1116 for interfacing the storage subsystem(s) 1114 to the system bus 1108 and other desired computer components. The storage subsystem(s) 1114 can include one or more of a hard disk drive (HDD), a magnetic floppy disk drive (FDD), and/or optical disk storage drive (e.g., a CD-ROM drive DVD drive), for example. The storage interface(s) 1116 can include interface technologies such as EIDE, ATA, SATA, and IEEE 1394, for example.

One or more programs and data can be stored in the memory subsystem 1106, a removable memory subsystem 1118 (e.g., flash drive form factor technology), and/or the storage subsystem(s) 1114, including an operating system 1120, one or more application programs 1122, other program modules 1124, and program data 1126. Generally, programs include routines, methods, data structures, other software components, etc., that perform particular tasks or implement particular abstract data types. All or portions of the operating system 1120, applications 1122, modules 1124, and/or data 1126 can also be cached in memory such as the volatile memory 1110, for example. It is to be appreciated that the disclosed architecture can be implemented with various commercially available operating systems or combinations of operating systems (e.g., as virtual machines).

The storage subsystem(s) 1114 and memory subsystems (1106 and 1118) serve as computer readable media for volatile and non-volatile storage of data, data structures, computer-executable instructions, and so forth. Computer readable media can be any available media that can be accessed by the computer 1102 and includes volatile and non-volatile media, removable and non-removable media. For the computer 1102, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 1102, programs, and data using external user input devices 1128 such as a keyboard and a mouse (e.g., the presenter mouse 1000). Other external user input devices 1128 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1102, programs, and data using onboard user input devices 1130 such a touchpad, microphone, keyboard, etc., where the computer 1102 is a portable computer, for example. These and other input devices are connected to the processing unit(s) 1104 through input/output (I/O) device interface(s) 1132 via the system bus 1108, but can be connected by other interfaces such as a parallel port, IEEE 1394 serial port, a game port, a USB port, an IR interface, etc. The I/O device interface(s) 1132 also facilitate the use of output peripherals 1134 such as printers, audio devices, camera devices, and so on, such as a sound card and/or onboard audio processing capability.

One or more graphics interface(s) 1136 (also commonly referred to as a graphics processing unit (GPU)) provide graphics and video signals between the computer 1102 and external display(s) 1138 (e.g., LCD, plasma) and/or onboard displays 1140 (e.g., for portable computer). The graphics interface(s) 1136 can also be manufactured as part of the computer system board.

The computer 1102 can operate in a networked environment (e.g., IP) using logical connections via a wire/wireless communications subsystem 1142 to one or more networks and/or other computers. The other computers can include workstations, servers, routers, personal computers, microprocessor-based entertainment appliance, a peer device or other common network node, and typically include many or all of the elements described relative to the computer 1102. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1102 connects to the network via a wired/wireless communication subsystem 1142 (e.g., a network interface adapter, onboard transceiver subsystem, etc.) to communicate with wired/wireless networks, wired/wireless printers, wired/wireless input devices 1144, and so on. The computer 1102 can include a modem or has other means for establishing communications over the network. In a networked environment, programs and data relative to the computer 1102 can be stored in the remote memory/storage device, as is associated with a distributed system. It will be appreciated that the network connections shown are exemplary and other means of establishing a communications link between the computers can be used.

The computer 1102 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated aspects can also be practiced in distributed computing environments where certain tasks are performed by remote processing devices that are linked through a communications network. In a distributed computing environment, program modules can be located in local and/or remote storage and/or memory system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multimode control system for a handheld device, comprising:
a signal assembly for imposing a signal on a tracking surface in a tracking mode;
a sensing assembly for sensing a reflected tracking portion of the signal from the tracking surface to track movement of the device relative to the tracking surface and a reflected switching portion of the signal from the tracking surface for mode switching; and
a switching assembly for automatically switching between the tracking mode and a different mode based on sensing of the reflected switching portion.

2. The system of claim 1, wherein the sensing assembly includes an image sensor that receives both the reflected tracking portion and the reflected switching portion, and the switching assembly automatically switches between the tracking mode and the different mode based on an integration of light received at the image sensor.

3. The system of claim 1, wherein the sensing assembly includes an image sensor that receives the reflected tracking portion to track the movement of the device and a photodetector for the sensing of the reflected switching portion.

4. The system of claim 1, wherein the signal assembly imposes an optical signal on the tracking surface for tracking movement of the device, the sensing assembly includes an optical detector for sensing the reflected switching portion of the optical signal from the tracking surface when the device is in contact with the tracking surface, and the switching assembly automatically maintains the device in the tracking mode in response to the sensing of the reflected switching portion.

5. The system of claim 1, wherein the signal assembly imposes an optical signal on the tracking surface for tracking movement of the device, the sensing assembly includes a photodetector for detecting the reflected switching portion of the optical signal from the tracking surface when the device is proximate the tracking surface, and the switching assembly automatically switches the device to the different mode in response to non-sensing of the reflected switching portion.

6. The system of claim 5, wherein the different mode is a presenter mode in which the device operates as a presenter device.

7. The system of claim 1, further comprising delay logic for delaying the automatic switching between the tracking mode and the different mode.

8. The system of claim 1, wherein the reflected portion of the signal is redirected through a signal path to the sensing assembly.

9. A multimode control system for a handheld device, comprising:
an optical assembly for imposing incident light on a tracking surface in a mouse mode;
a sensing assembly for sensing reflected tracking light from the tracking surface to track movement of the device relative to the tracking surface and sensing reflected switching light for mode switching, the sensing assembly includes an image sensor that senses the reflected tracking light and a photodetector that detects the reflected switching light;
a switching assembly for automatically switching between the mouse mode and a presenter mode based on sensing of the reflected switching light; and
delay logic for delaying the automatic switching between the mouse mode and the presenter mode according to a delay value.

10. The system of claim 9, wherein the device is a presenter mouse and the photodetector is a photodiode.

11. The system of claim 9, wherein the optical assembly employs a laser light source for imposing the incident light, the light source employed in combination with a lens arrangement that provides directed light to the photodetector along a specular path.

12. The system of claim 9, wherein the reflected switching light is rerouted off a specular path to an offset position of the photodetector using an arrangement of optical elements.

13. The system of claim 9, wherein the optical assembly employs an LED light source for imposing the incident light, the light source employed in combination with a lens arrangement that provides directed light to the photodetector along a specular path.

14. A method of multimodal optical switching, comprising:
imposing incident light on a tracking surface;
detecting specular light on an optical sensing assembly; and
automatically switching between a tracking mode and a different mode based on the detected specular light.

15. The method of claim 14, further comprising integrating the specular light on the optical sensing assembly and comparing the integrated specular light against a threshold level to determine switching between the tracking mode and the different mode.

16. The method of claim 14, further comprising routing a tracking portion of reflected light to an image sensor of the optical sensing assembly for tracking movement relative to the tracking surface and routing the specular light to a photodetector for switching between the tracking mode and the different mode.

17. The method of claim 16, further comprising redirecting the specular light to the photodetector when the photodetector is offset from a main specular path.

18. The method of claim 14, further comprising introducing a time delay before switching between the tracking mode and the different mode.

19. The method of claim 14, further comprising performing an image comparison, results of which indicate switching between the tracking mode and the different mode.

20. The method of claim 14, wherein the tracking mode is a mouse mode and the different mode is a presenter mode.
